(19) United States
(12) Patent Application Publication
(10) Pub. No.: US 2010/0323763 A1
(43) Pub. Date: Dec. 23, 2010

(54) COMMUNICATIONS SYSTEM

(76) Inventors: Pirow Englebrecht, Royston (GB); David R. Tegerdine, Royston (GB)

Correspondence Address: NIXON & VANDERHYE, PC, 901 NORTH GLEBE ROAD, 11TH FLOOR, ARLINGTON, VA, 22203, US

(21) Appl. No.: 12/680,442

(22) PCT Filed: Aug. 15, 2008
(86) PCT No.: PCT/GB2008/002789

§ 371 Date: Mar. 26, 2010

(30) Foreign Application Priority Data
Sep. 27, 2007 (GB) 0718897.2

(51) Int. Cl. H04W 88/02

(52) U.S. Cl. 455/566

(57) ABSTRACT

Communications system is described comprising a first processor (40) arranged to run an operating system which, in use, provides user access to one or more communications services and a first user interface for presenting on a display means (52) of the system data associated with operation of the or each communications service. The system includes a second processor (54) arranged, in response to user initiation, to run a program associated with a TV and/or Radio service broadcast using the Digital Audio Broadcast (DAB) service. In response to initiation of said program, the second processor is arranged to present on the display means, in place of the first user interface, a second user interface for presenting data associated with TV and/or Radio service.

The present invention relates to a communications system, and particularly, though not exclusively, a communications system arranged to receive and display digital data representing video and/or audio information.

It is well known to provide a portable communications system for receiving digital video and/or audio information from a remote transmitting source. Given the widespread ownership of mobile telephones and personal digital assistants (PDAs) in recent times, various service providers now provide, or propose to provide, video and/or audio content for output on such devices. The content may represent, for example, a live television feed, archived video content and so on. This has lead to the emergence of a number of so-called mobile digital television (MDTV) standards and technologies that, as will be appreciated by those skilled in the art, include digital audio broadcast (DAB), digital media broadcast (DMB), digital video broadcast (DVB), DVB-T (terrestrial), DVB-H (handheld), DVB-SH, MediaFLO, T-DMB, DAB-IP, TMMB, ISDB-T, CMMB and DMBT. These standards define protocols for transmitting and receiving the video and audio data.

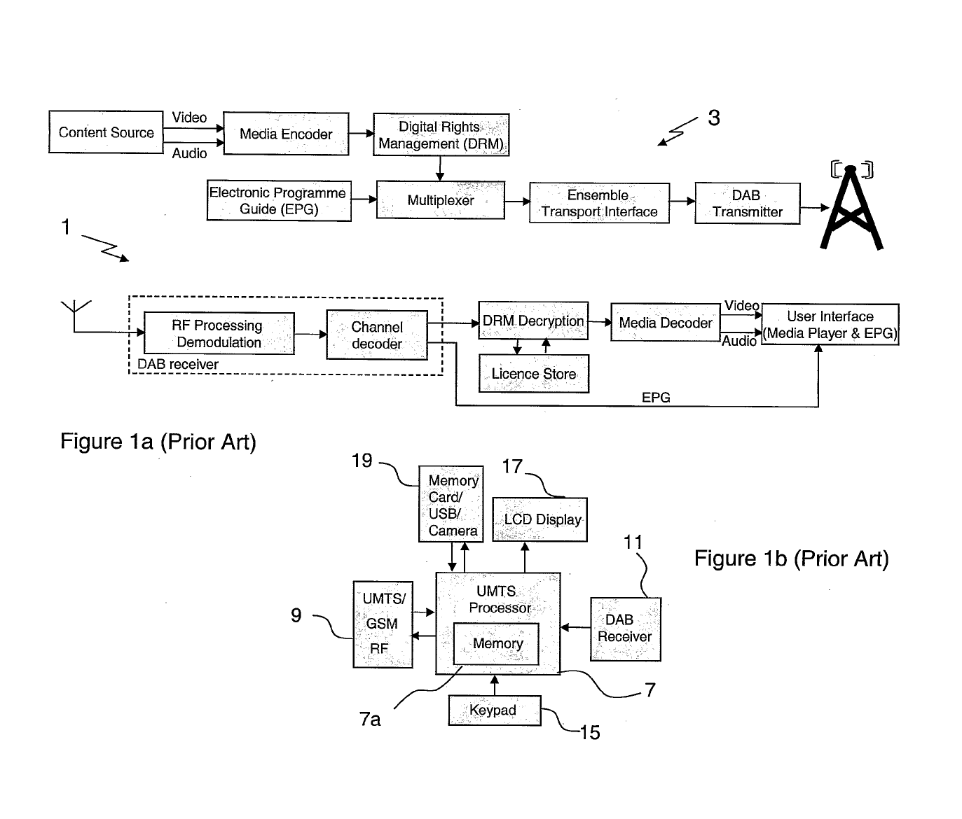

FIG. 1 a is a functional block diagram of such a system comprising a mobile telephone receiver 1 and a service provider head end 3. Operation of the head end 3 will not be described in detail, other than to say that the video/audio content is encoded using a suitable codec (e.g. Microsoft® Media Encoder 9), digital rights management (DRM) encryption performed (e.g. using Microsoft® DRM 10) and the encoded, encrypted content placed into one of a number of DAB multiplexes or channels for transmission using a DAB transmitter. The receiver 1 performs substantially the reverse operation by means of a DAB receiver, DRM decryption software, video/audio decoding software and a user interface for outputting the video/audio. Electronic Programme Guide (EPG) data is also transmitted from the head end 3 to the receiver 1.

FIG. 1b is a block diagram showing hardware components of the prior art receiver 1.

This hardware includes a Universal Mobile Telephone Service (UMTS) processor 7 having access to memory 7a. Connected to the processor is a UMTS/GSM r.f. transceiver 9, a DAB antenna and receiving system 11, a keyboard 15, a LCD display 17, additional input/output facilities 19 including a memory card port, USB port, and camera. Stored in the memory 7a is the operating system of the telephone which provides an interface via which the user can access conventional telephony, messaging and related functions. Also provided in the memory 7 is a so-called TV application.

The TV application provides a graphical user interface (GUI) for presenting an electronic programme guide (EPG) from which a user selects a television or radio service. The software further includes media playing software which has access to one or more codecs for decoding the selected data stream, and digital rights management (DRM) software for decrypting data streams that have been encrypted at the service provider headend 3. DRM is a form of access management by means of which service providers can control who can access and decode their content, or particular channels of content, in return for a one-off payment or long term subscription. The service provider uses the head end DRM software to encrypt the content data with a ‘key’. To decrypt the encrypted content, the subscribing user obtains a corresponding decryption key (either from the service provider or a third party agent of theirs) which is then securely stored in memory for use by the receiver DRM software when the relevant encrypted channel is selected.

In practice, the UMTS processor needs sufficient processing power to control the DAB receiver, run the TV application and process the incoming video/audio data such that the data can be output at the required resolution and refresh rate, e.g. 320×240 16 bit pixels at 30 frames/second. In addition, the TV application and operating system need to be compatible so that the video/audio decoders, DRM software and the media playing software can operate correctly. This limits the type of receiver handset to which such a video/audio receiving function can be applied, particularly since handset manufactures tend to use their own preferred family of processors and operating systems. At the low to mid-range of the handset market, processors tend to have insufficient processing power to run such video/audio functionality efficiently.

It would therefore be desirable to provide video and/or audio receiving functionality to a wide range of handset families notwithstanding the particular host processor and/or operating system employed.

According to a first aspect of the invention, there is provided a communications system comprising first and second processors arranged to run respective first and second programs each associated with a different communications service, and a display means, wherein the second processor is electrically connected between the first processor and the display means and arranged such that, in a first operating mode in which the second program is inactive, display data generated by the first program is transferred to the display means via the second processor, and in a second operating mode in which the second program is active, display data generated by the second program is output to the display means in place of display data from the first processor.

In the first operating mode, the second processor may be arranged to provide a direct link between the first processor and the display means.

The system may further comprise user control means connected to the first processor, and wherein, when run in the second operating mode, the first processor may be arranged in use to transfer control data from the user control means to the second program.

The second processor may be arranged, in the second operating mode, to receive notification data from the first processor and subsequently to cause the second program to indicate in its display data receipt of said notification data. The notification data may be indicative of an incoming communications request received by the communications service provided on the first processor, the second program being arranged to indicate in its display data the incoming communications request and to enable user acceptance of the incoming request. In response to user acceptance of the incoming request, the second program may be arranged to transfer user control, at least temporarily, to the communications service on the first processor.

The first and second processors are preferably powered by respective power supplies which are independent of one another, and wherein, when the communications service program is inactive, the second processor power supply is arranged automatically to enter a low power state relative to the first processor power supply.

The communications system is preferably a wireless communications system, for example, a mobile telephone or PDA in which the first processor is connected to a UMTS/GSM transceiver and provides one or more voice communications services.

The first processor may be connectable to an Internet protocol (IP) node and the second processor can be operable, in the second operating mode, to initiate connection to an available IP node via the first processor. The first processor may be connectable to the IP node via an associated GPRS transceiver for detecting and establishing a connection with an available IP node.

The second processor may be connected to a digital broadcast receiver and the second program is arranged to decode content received therefrom for output to the display means. The digital broadcast receiver may be arranged to receive video and/or audio content conforming to a digital audio broadcast (DAB) standard protocol and the second program arranged to decode the received content for output to the display means. The second program is preferably arranged to decode content from a selected one of a plurality of channels received at the digital broadcast receiver.

In the preferred embodiment, the first and second processors are physically separate and interconnected by one or more data buses.

The first program may be an operating system providing a plurality of communications functions, including voice and data call functions.

According to a second aspect of the invention, there is provided a communications system comprising: a first processor arranged to run an operating system which, in use, provides user access to one or more communications services and a first user interface for presenting on a display means of the system data associated with operation of the or each communications service; and a second processor arranged, in response to user initiation, to run a program associated with a further communications service, wherein in response to initiation of said program, the second processor is arranged to present on the display means, in place of the first user interface, a second user interface for presenting data associated with the further service.

According to a third aspect of the invention, there is provided a method of operating a communications system comprising first and second processors arranged to run respective first and second programs each associated with a different communications service, the second processor being electrically connected between the first processor and a display means, the method comprising: in a first operating mode in which the second program is inactive, transferring display data generated by the first program to the display means via the second processor; and in a second operating mode in which the second program is active, outputting display data generated by the second program to the display means in place of any display data from the first processor.

According to a fourth aspect of the invention, there is provided a method of operating a communications system comprising: a first processor arranged to run an operating system which, in use, provides user access to one or more communications services and a first user interface for presenting on a display means of the system data associated with operation of the or each communications service; and a second processor arranged, in response to user initiation, to run a program associated with a further communications service, wherein the method comprises, in response to initiation of said program, operating the second processor to present on the display means, in place of first user interface, a second user interface for presenting data associated with the further service.

The invention will now be described, by way of example, with reference to the accompanying drawings, in which:

FIG. 1 is a block diagram showing functional and hardware elements of a prior art system for broadcasting and receiving video and/or audio data;

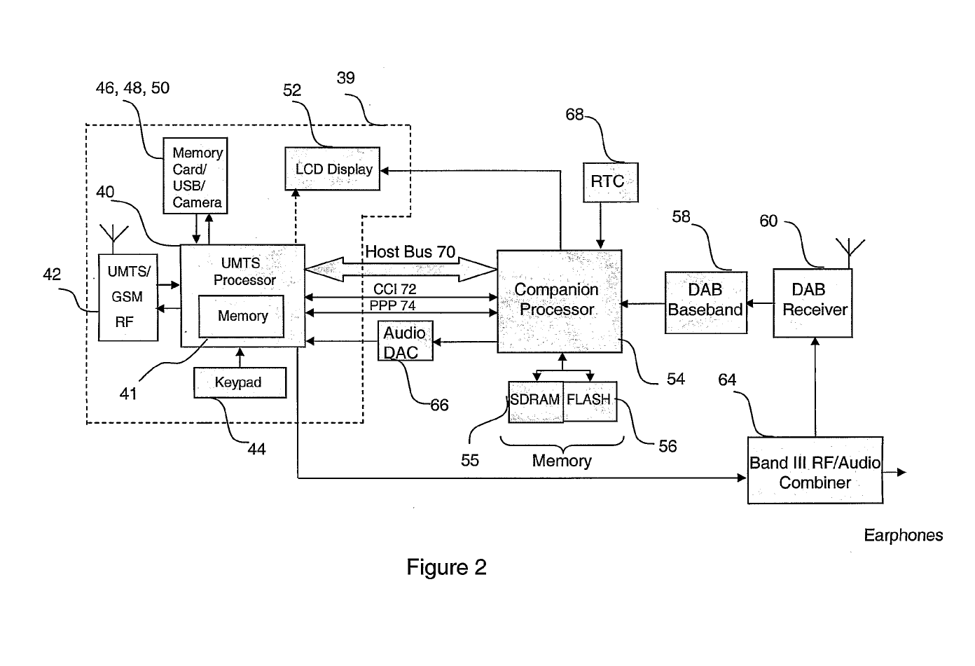

FIG. 2 is a block diagram showing elements of a system providing a video/audio data service in accordance with a first embodiment of the invention;

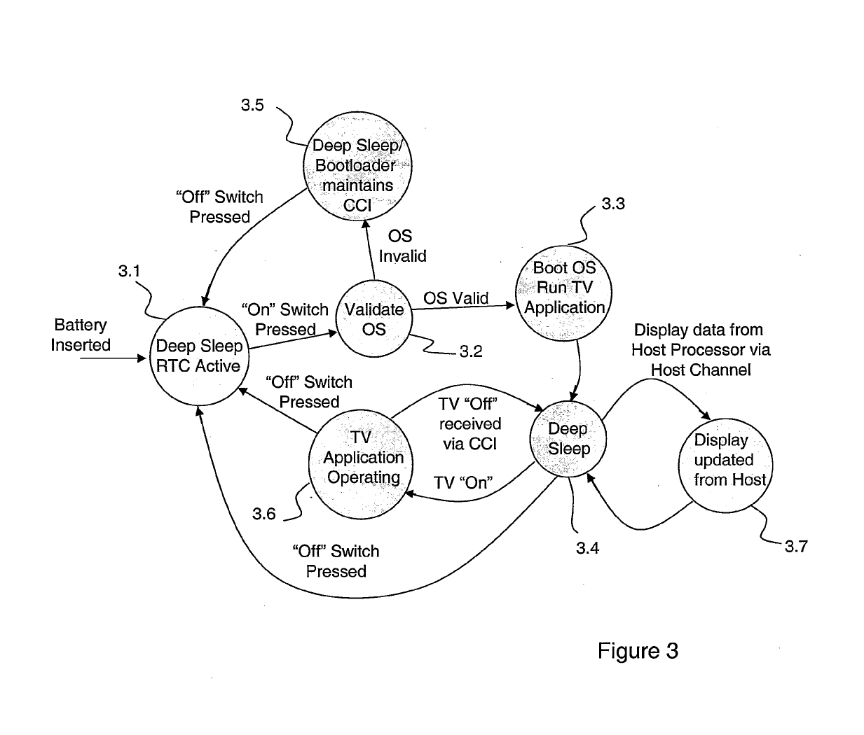

FIG. 3 is a state diagram showing different operating modes of software running on a co-processor element of the device shown in FIG. 2;

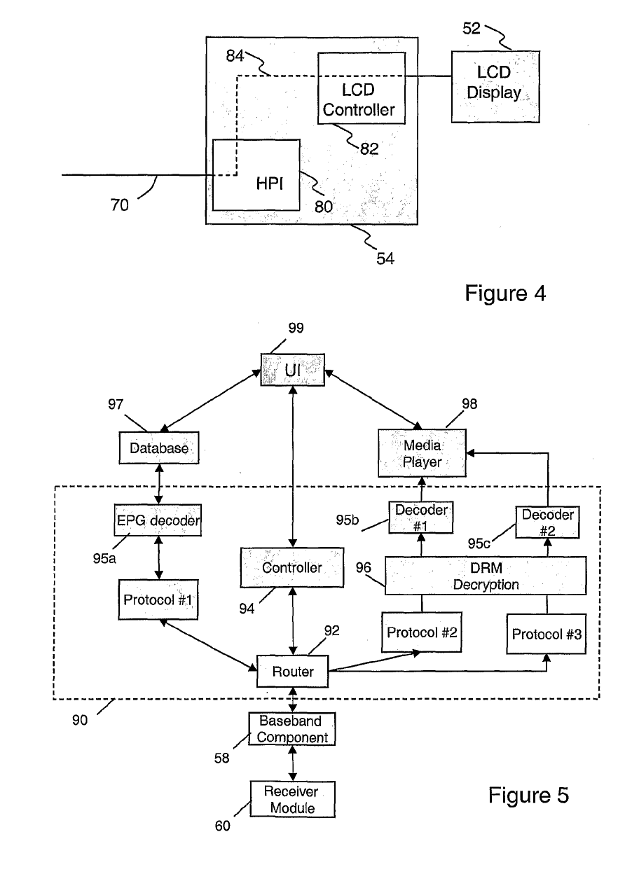

FIG. 4 is a block diagram useful for understanding operation of the co-processor element shown in FIG. 2 when operated in an inactive mode;

FIG. 5 is a flow chart indicating the logical flow of streaming audio/video data from a DAB receiver to a user interface;

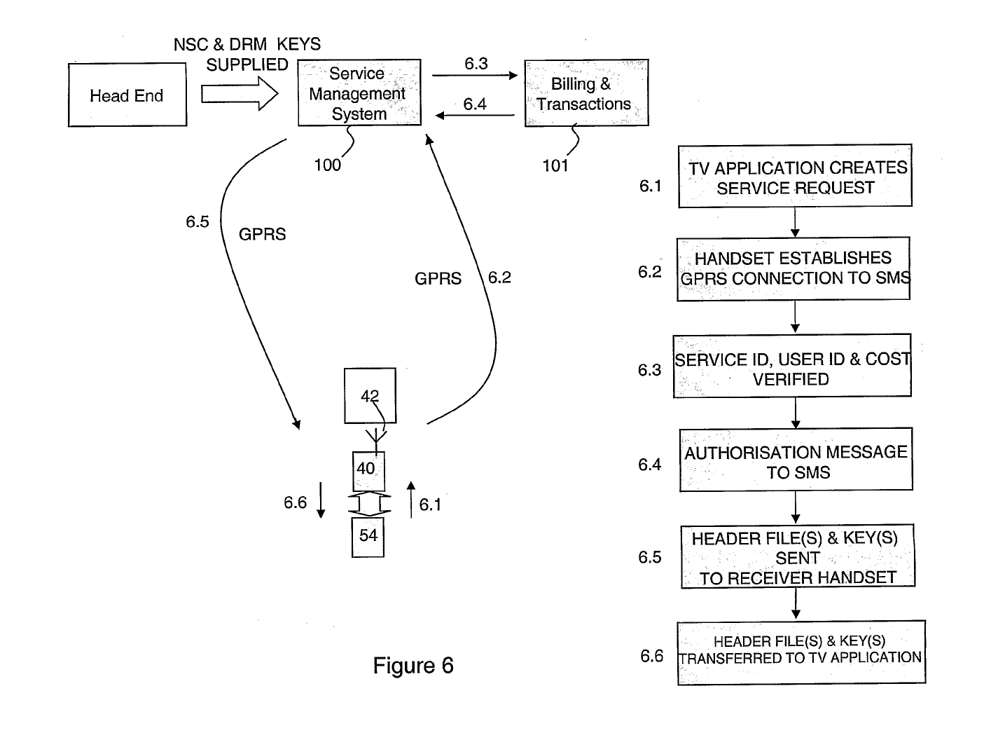

FIG. 6 is a block diagram and accompanying flow chart showing steps in a provisioning operation for acquiring licence information;

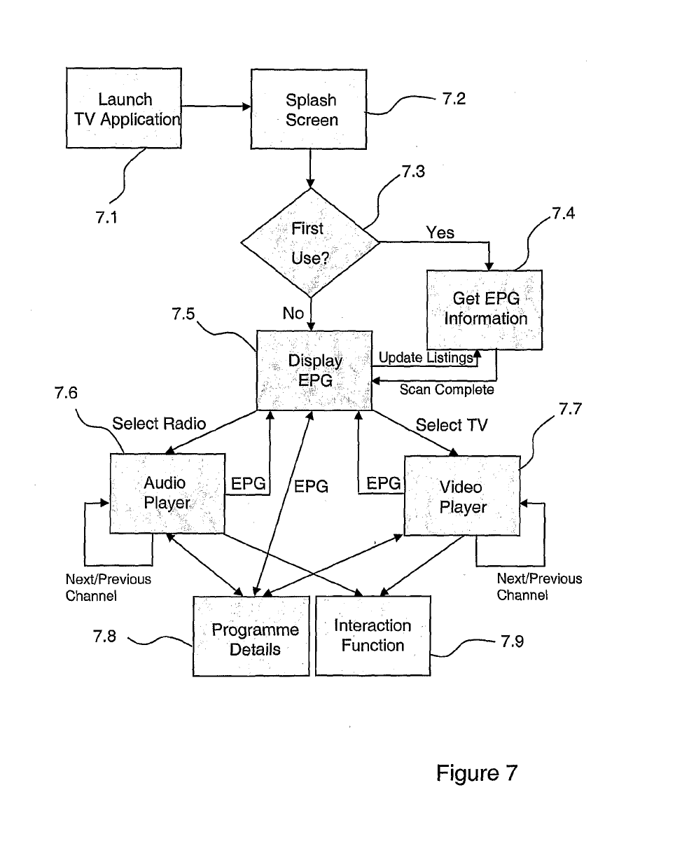

FIG. 7 is a flow chart showing different states in which software run on the communications system can operate; and

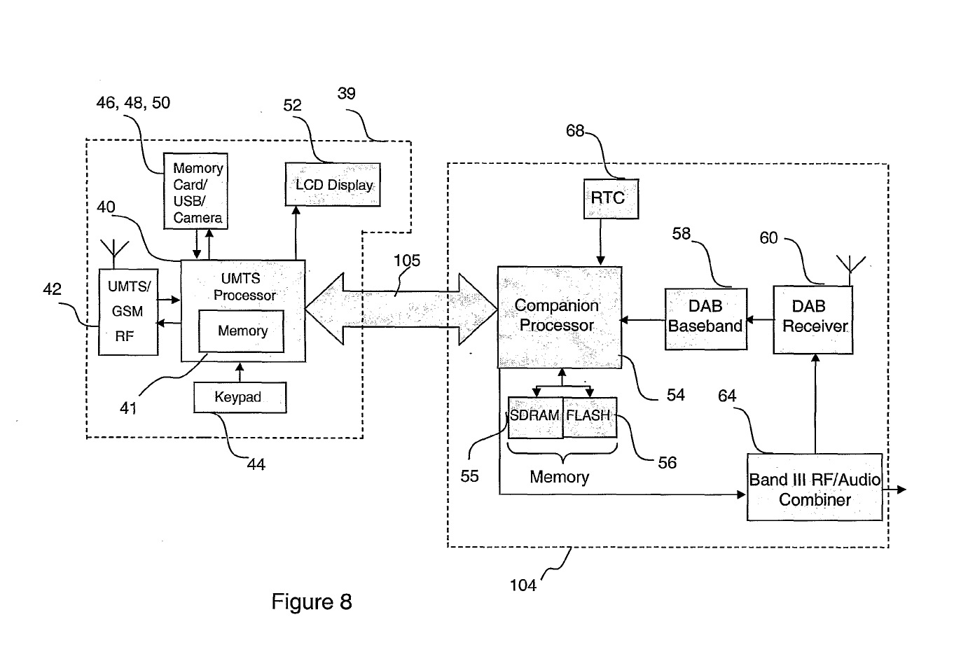

FIG. 8 is a block diagram showing elements of a system providing a video/audio data service in accordance with a second embodiment of the invention.

Referring to FIG. 2, a block diagram is shown representing components of a communications system providing video and audio receiving and output functionality. In this embodiment, the communications system is a mobile telephone handset having additional hardware and software for receiving video and audio data from a DAB broadcast channel. The described architecture enables this functionality to be conveniently integrated into a wide range of existing telephone handsets thereby enabling them to provide, for example, a TV and/or radio service, notwithstanding the fact that different handset manufacturers use different host processors, architectures and operating systems which may otherwise make the handset unsuitable for providing such a service. The architecture is not limited to mobile telephone handsets and can be integrated into, for example, PDAs or even laptop computers.

Components representing the handset's architecture prior to the proposed modification are shown within dotted line 39 and include a host processor 40, memory 41, a UMTS/GSM receiver and antenna 42, keyboard 44, memory card, USB port and camera 46, 48, 50 and a colour LCD display device 52. As will be explained below, the connection between the host processor 40 and the display 52 is inhibited and access to the display is controlled by the additional hardware. The operation of this architecture will not be described in detail at this stage, other than to say that the host processor 40 is arranged to run a first operating system which is stored in the memory 41. The host processor 40 and operating system may be any standard device and operating system currently provided by handset manufacturers such as Nokia, Motorola, Sony Eriksson and so on. The host processor 40 and operating system enable standard 2.5/3G telephone functionality, including the ability to initiate and accept voice and data calls and to send and receive SMS and MMS messages via the UMTS/GSM transceiver 42. The memory card 46 can store executable programs, e.g. games, as well as photographs and video clips acquired via the camera 50.

To provide the additional DAB video and audio receiving functionality, additional components are provided. These include a so-called companion processor (hereafter referred to as the co-processor) 54 which is connected to the host processor 40 by a plurality of channels including host bus 70, a command and control interface (CCI) 72, a point to point channel (PPP) 72. The latter two channels 72, 74 are implemented as universal asynchronous receiver/transmitter (UART) channels. The co-processor 54 is also connected to memory, in particular a synchronous dynamic RAM (SDRAM) memory 55 and flash memory 56 which store various software elements operated by the co-processor, as well as to a DAB baseband chip 58, a dedicated real time clock (RTC) 68 and the abovementioned display 52 of the handset. The DAB baseband chip 58 is in turn connected to the DAB receiver 60 by a serial peripheral interface bus (SPI) which receives the DAB broadcast signals via an L-band antenna 62. The DAB baseband chip 58 converts the received DAB signals to baseband for processing by the co-processor 54. A Band III/Audio combiner 64 is connected between the DAB receiver 60 and the host processor 40. An audio digital to analogue (DAC) converter chip 66 is arranged between the host processor and co-processor 54 for converting the digital audio data for output using the handset's speaker and/or a connected headset via the Band III/Audio combiner 64.

The co-processor 54 operates under the control of an operating system which also enables execution of a dedicated TV application. The TV application, which will be described below, provides a graphical user interface (GUI) for enabling selection and display of the video and/or audio content streams receivable by the DAB receiver 60. This is done by presenting an EPG which displays a plurality of selectable content channels currently available. The TV application also has access to media playing software as well as codecs for decoding the video/audio for output to media playing software provided as part of the GUI. The operating system may be, for example, Microsoft Windows CE or Microsoft Mobile OS. Microsoft® Windows Media Player 9 could be used as the media playing software. Suitable codecs might include MPEG-1, MPEG-2, MPEG-4, H.264, AAC+ and so forth. In addition, assuming the service provider encrypts the video/audio data prior to broadcast using a DRM facility such as Microsoft® DRM 10, a complementary DRM application will be required as part of the software for decrypting the encrypted content in accordance with licenses that will have to be acquired in advance of receiving the data. The operating system, TV application, media playing software, codecs, DRM application and licences will be stored in the co-processors associated memory, i.e. in the SDRAM 55 and/or in the flash memory 56.

In overview, the operation of the architecture shown in FIG. 2 is such that the host processor 40 functions in a conventional manner until such time as the co-processor 54 is in an active state. Said activation is done by means of executing the TV application by selecting a menu item presented in the host processor's own user interface. Such selection can also be achieved using a dedicated hard key on the external surface of the handset. Upon executing the TV application, the co-processor 54 enters its active state and, at this point, takes control of the display 52. Prior to this, the co-processor bypasses display data received from the host processor 40 to the display means 52. In all, the co-processor 54 has three main operating states which are defined as:

Standby: host processor 40 is in standby mode with display inactive and the TV application inactive; in this state the co-processor 54 is in a low power state whilst maintaining its RTC 68;

Inactive: host processor is active with host operating system permitting voice and/or data calls; TV application is inactive; in this state the co-processor is in a low power state but with its host port active to allow display data from the host processor to be passed to the display;

Active: TV application activated; in this state the co-processor is raised from the low power state to an operating power state and display data from the co-processor, i.e. the TV application's user interface and/or media player, takes control of the display device in preference to display data from the host processor 40; additionally, user inputs from the keyboard 44 are transferred from the host processor to the co-processor for controlling the TV application.

It will therefore be appreciated that, when the TV application is initiated, the co-processor takes control of the display 52 from the host processor 40 in order to display a menu screen, EPG or the content. Where the co-processor output does not fill the whole display area, the output from the host-processor 40 may be displayed in the remaining uncovered area, i.e. so that the co-processor output appears effectively to lie on top of the host processor output. Otherwise, the host processor 40 operates as normal with display data being transferred via the co-processor 54 in its low power state. This bypassing may be achieved by setting up a direct link between input and output pins of the co-processor 54.

When the TV application is active, it should be appreciated that the host operating system remains active. In this way, incoming voice, messaging or data calls can be notified whilst the user is viewing or listening to content. In this case, the host operating system passes a control message over the CCI channel 72 which is received by the co-processor's operating system. Upon receipt, the TV application updates its display information to present an overlaid indication of the incoming call or message. This may include presenting the caller's number and/or name. Preferably, the TV application in this case gives the user the option to accept the call or read the message. If accepted, the TV application may terminate, either temporarily until the call is itself terminated, or until the user again selects the TV application at a later stage.

Further features and/or characteristics of the architecture will now be briefly described.

### Host Bus 70 and Host Port Interface (HPI) 80

The host bus 70 is used principally to transfer display data, i.e. video data from the host processor 40 to the display 52 via the host port of the co-processor 54. To facilitate this, the co-processor 54 provides a HPI 80. In this case, video data is displayed at a resolution of 320×240 pixels at 30 frames per second with 16 bits encoding each pixel. The host bus 70 is deigned to carry data at 4.6 Mbits per second to comfortably carry the data. A frame buffer of 150 Kbytes is provided in a LCD controller of the co-processor 54 to store complete frames for output to the display 52, although come displays have an integral buffer built-in. A secondary use of the host bus 70 and HPI 80 is to permit access by the co-processor 54 to the host's file system, e.g. to read/write files from/to the memory card 46 or another device connected to the USB 48. A requirement of the host bus 70 and HPI 80 is to enable the abovementioned data throughput in the co-processor's low power inactive state. Transactions performed over the host bus 70 are negotiated using the CCI 72. Other than for 3rd Generation (3G) streaming, the CCI 72 is used to signal completion of all host port transfers. 3G may make use of interrupts between the host processor 40 and the co-processor 54 to signal completion of 3G stream data transfers as to minimise processing delay. The host processor 40 may implement the necessary read/write operations to access the host port in an indirect addressing mode. A segmented addressing mode may also be supported. The host processor 40 may also implement the necessary interrupt service routines for handling the interrupts generated by the co-processor 54.

As indicated above, in order for the host processor 40 to stream video data to the display 52, it is necessary to transfer data from the host processor to buffer memory in a controller 82 associated with the display 52. As indicated in FIG. 4, this is done using the co-processor's HPI 80. In this way, the host processor 40 can directly access the display 52 via the HPI 80 which has two significant advantages. Firstly, when the co-processor 54 is inactive, it can be put into a very low power mode. Secondly, since no software is required to execute on the co-processor 54, the display 52 is available to the host operating system as soon as co-processor is booted up, i.e. when the handset is powered up. This permits the phone to display a splash screen immediately following power up.

As indicated previously, display ownership is determined by the co-processor 54 and request messages passed over the CCI 72 from the TV application. The sequence of events for the host processor 40 to display data via the co-processor 54 is as follows:
1) Host writes to wake-up bit in co-processor HPI control register;
2) Co-processor wakes up and starts processor clock;
3) Host waits for ‘x’ ms to allow co-processor clock to stabilise;
4) Host writes data to display controller 82 via HPI
5) Host issues sleep command via CCI (this informs the co-processor that the display has been updated and processor can enter low power mode); and
6) Co-processor sends acknowledgment command over CCI.

As also mentioned above, a secondary use of the host bus 70 and HPI 80 is to permit access by the co-processor 54 to the host's file system. The sequence of events for file transfer over the host bus 70 is as follows:

### Read File

1) Co-processor sends a “Read File” request over CCI to host processor; Messages includes a file handle, a pointer to a buffer in memory to place the file contents and the number of bytes to read from the file;
2) The host processor interprets the “Read File” request and transfers the requested file contents over the HPI to the buffer in the co-processor's memory;
3) The host processor signals to the co-processor 54 that the transfer has been completed by sending a “Read File” request response to the co-processor; this includes the amount of bytes actually read from the file.

### Write File

1) Co-processor sends a “Write File” request over the CCI to the host processor; message includes a file handle, and a pointer to a buffer in memory to read the file contents from and the size of the buffer.
2) Host processor interprets the “Write File” request and reads the buffer contents over the host port and writes it to the open file;
3) Host processor signals to the co-processor that the write has been completed by sending a “Write File” request response to the co-processor. This includes the amount of bytes actually written to the file.

### Command and Control Interface (CCI) 72

As indicated above, the CCI 72 is a UART serial interface used primarily for low data rate command and control instructions between the host processor 40 and the co-processor 54. Control instructions for initiating and terminating read and/or write commands between the processors is the CCI's principle role as explained above with reference to the host bus 70 operation.

### Point to Point Interface (PPP) 74

The PPP 74 is another UART serial interface providing a virtual TCP/IP channel for the co-processor 54 via the host processor 40 and its enabled GPRS facility provided by the UMTS/GSM transceiver 42. An internet connection is therefore independently available to the co-processor 54. In this respect, the TV application provides an interactive data service in which information relevant to the content being viewed or listened to can be acquired from the Internet for display in the application's GUI whilst the video and/or audio is playing. For example, if the user is viewing a sports event, he or she can initiate an interactive service by pressing a dedicated hard key or menu command which causes information, identifying the viewed programme and handset, to a interactive server over the Internet connection. The interactive server then acquires data or web pages associated with the identified program and sends these back over the Internet for display in a browser.

Two main options are provided to allow the co-processor 54 to connect to the Internet via the PPP 74. In a first option, the host processor 40 acts as bridge between incoming PPP connection from the co-processor 54 and an outgoing PPP connection to the wireless GPRS network. Proxy server connections and proxy authentication is managed by the co-processor 54. When such a PPP bridge is in operation, the host processor 40 cannot access the Internet. In a second option, the host processor 40 acts as gateway between the co-processor 54 and the Internet. The host processor 40 runs a Dynamic Host Communication Protocol (DHCP) server to issue the co-processor 54 with an IP address. In this case, the Internet gateway handles proxy server authentication.

### Power Supplies

Each of the host processor 40 and co-processor 54 have their own power supplies (not shown) which are independent of each other, that is one power supply can be changed without affecting the other power supply. This enables the co-processor 54 to enter its low power state when inactive whilst the host processor 40 is active. The co-processor 40 power supply also includes a battery backup function to support the RTC 68 which is used in the DRM function for verifying user privileges/licences. The RTC 68 is separate from the RTC 68 used for the host processor 40.

### Co-Processor Boot Software

The co-processor boot software is controlled by boot code stored in the Flash memory 56. The boot code is stored in separate sectors than other software such as the operating system and TV application to permit independent erasure and programming. There are two types of boot-up operation, namely a cold reset which occurs when the battery is inserted into the handset, and a warm reset which occurs when the handset is switched on.

The boot software is initiated following a ‘power on reset’ (battery inserted or a reset signal sent from the host processor 40) and operates to verify the integrity of the operating system and to initiate it if valid. The boot software also supports CCI communications with the host processor 40 and has the facility to re-program parts of the flash memory to permit software downloading.

Reference is now made to FIG. 3, which is a state diagram indicating the various phases of the boot operation and resulting states of co-processor 54. In a cold boot, the boot software is executed immediately following power on reset, the RTC 68 initialised (if it is not already running) and then causes the co-processor 54 to enter a deep sleep state (state 3.1). To give the user feedback of the power up, a splash screen is displayed. The host processor 40 takes control of the display when the co-processor 54 completes its reset state.

In a warm boot, i.e. when the handset's ‘on’ switch is pressed, the host processor 40 will boot up. The host processor 40 sends a message to co-processor 54 to indicate that the ‘on’ key has been pressed. On receipt of this command, the state of the co-processor's operating system is verified (state 3.2). If valid, the operating system is initiated (state 3.3). On completion of operating system boot up, it will configure the DDR RAM for low power self-refresh before returning to a deep sleep (low power) state (state 3.4). If the operating system is not valid, the boot software will process incoming CCI commands in a deep sleep state thereby enabling normal operation of the host processor 40 (state 3.5).

Assuming the operating system is valid, when the TV application is initiated by a user, the application is run and the co-processor 54 executes normally (state 3.6). Since the co-processor operating system was booted previously on power on, the TV application will be available in a short amount of time. If the user exits the TV application, the co-processor operating system will perform housekeeping duties before configuring DDR RAM for a low power self refresh before entering a deep sleep low power state (state 3.1). The deep sleep state enables rapid execution of the TV application if the user initiates it subsequently.

If the handset is switched ‘off’ the DDR RAM is not set to self refresh to minimise quiescent current.

State 3.7 indicates that, whilst the co-processor 54 is in the deep sleep state, display data is being received from the host processor 40 via the host bus 70.

### DAB Receiver Components 58, 60 & TV Application

Although not essential for understanding the invention, there is now described the operation of the DAB receiver components 58, 60 in conjunction with those aspects of the TV application's operation which enable receipt, selection and output of video and/or audio from the received DAB broadcast. FIG. 5 is a schematic diagram showing functional components of an embodiment of the TV application 90. Although FIG. 5 is described with reference to DAB technology, it will be apparent to those skilled in the art that the functionality described herein in the context of DAB standard technology may be implemented using other digital broadcast technology.

In FIG. 5, the TV application 90 includes a DAB receiver application which is supported by the operating system of the co-processor 54 and comprises means to exchange control and receiving signaling information from the receiver circuitry (the hardwired DAB RF receiver 60) and the DAB baseband component 58 which provides a suitable driver, for example a Serial Peripheral Interface Driver, for receiving a plurality of baseband sub-channels from the receiver module 60. The DAB receiver application comprises a number of components, including a router component 92, which is controlled via a controller component 94 (which interfaces with the user interface). Unless the sub-channels are received in a de-multiplexed form, prior to the routing operation, a demultiplexing operation will be performed. Router 92 selectively routes received sub-channels according to their type and protocol to one or more decoder components 95a,b,c. Decoder 95a is arranged to decode EPG data conveyed by a sub-channel conforming to a first protocol #1. Each EPG file is then processed in the manner described in more detail herein below to generate individual programme records which are stored in data store 97. Decoders #1 and #2 95b,c are arranged to decode bearer sub-channels conforming to protocols #2 and #3, for reproduction of the various service components on video/audio output means provided as part of the TV application, namely media playing software 98 which forms part of the user interface 99. Between the router 92 and the respective decoders 95b,c is a Digital Rights Management (DRM) decryption system 96 which handles decryption of data streams that have been decrypted prior to broadcast. These will generally be pay-per-view channels requiring user payment in return for which the relevant decryption keys are supplied to the receiver to enable decryption when the particular channel is selected.

The sub-channels received via the channel(s) from the DAB baseband driver 58 comprise one or more bearer sub-channels for audio and/or video entertainment channels and one or more data-bearing sub-channels conveying EPG information for the received plurality of sub-channels. The sub-channels received by a router component 92 of the TV application 90 will all have the same multiplex frequency (unless the DAB receiver module 60 is arranged to simultaneously receive a plurality of DAB channel multiplexes at different frequencies and provide these to the TV application 90). Router component 92 may be provided in a pre-configured or a configurable/reconfigurable form (and by analogy partly implemented in hardware and/or in software).

The DAB receiver module 60 outputs bearer and data channels which are partially decoded to the extent that the TV application 90 is capable of identifying which one or more of a plurality of bearer and/or data channels received from the DAB receiver module 60 should be further decoded by the TV application 90 using signaling information received from the DAB receiver module 60 and in accordance with control information provided by the user through the user interface (UI) 99. In one embodiment of the invention, the bearer and data channels remain in a multiplex form, i.e., time-division multiplexed, when output by the DAB receiver circuitry to the TV application components.

When router 92 receives the plurality of bearer sub-channels and a data sub-channel comprising EPG information for the received multiplex from the DAB receiver module 60, the router 92 is configured to distribute one or more received sub-channels to an appropriate decoder component(s) via the DRM decryption system 96. In FIG. 5, a plurality of decoder components 95a,b, and c are shown.

In the exemplary embodiment shown in FIG. 5, three sub-channels are extracted from a received multiplex for decoding by the TV application 90. Router 92 separates the sub-channels for processing by additional components of the TV application 90. As shown in the exemplary embodiment of FIG. 5, each sub-channel conveys a signal. These represent different service components, for example, one sub-channel conveys EPG information, and the other two may convey components of one or two different entertainment channels.

In FIG. 5, a received sub-channel conforming to protocol #1 is decoded by an EPG decoding component 95a, and processed as described in more detail herein below. The decoded, processed EPG information is then stored in a database 97. Bearer Sub-channels conforming to differing protocols #2 and #3 are routed to respective decoders 95b and 95c via the DRM decryption system 96. As indicated above, the DRM decryption system 96 ensures that the decoders 95b,c can only decode source encoded sub-channels provided the required decryption keys have been transferred to the secure memory 55, 56 associated with the co-processor 54. In the case of free-to-air services, the DRM decryption system simply passes the data onwards to the relevant decoder 95a, 95b. Although two simultaneous decoders 95a,b are shown in FIG. 5, one decoder is sufficient if recording and simultaneous viewing of an alternative sub-channel is not required. Alternatively, one decoder may be used to decode an audio sub-channel and another a video sub-channel for service components which are part of the same or differing service channels of the same ensemble. In one embodiment, companion data services are provided using one or more sub channels.

A decoded sub-channel is provided in a form which enables appropriate reproduction by the media playing application 98. The operation of the DAB application in terms of which sub-channel (or more than one sub-channels if recording features are implemented as described above) is selectively decoded from a multiplex of sub-channels received from the DAB module is controlled by the user through the user interface 99 which is provided with EPG information from the database 97 of EPG content. The selection may be implemented by the controller 94 which is controlled by the user interface component 99 in one embodiment of the invention to enable selection of one or more specific sub-channels for delivery of a service channel to audio and/or video output means of the mobile communications device.

To enable the controller 94 to selectively control which sub-channels are required for decoding a particular service channel, the router component 92 is also reconfigurable. Each sub-channel in the TDM multiplexed content stream which passes through the interface between the DAB receiver module 60 and the TV application 90 running on the co-processor's operating system is capable of being identified in the multiplexed stream using signaling information (e.g. the FIC) which accompanies the MSC information in the DAB multiplex signal. The co-processor 54 implementing the routing function uses the signaling information generated by partially decoding the received DAB multiplex to determine what sub-channels require decoding. The information to identify individual sub-channels in the received data stream can be provided by the DAB receiver module 60 over the interface with the TV application 90.

DAB receiver module 60 outputs a DAB ensemble comprising multiple service channels sharing one or more DAB bearer sub-channels in which each service channel is separately identified by having its own DAB service ID. The DAB service ID information enables each sub-channel to be mapped by the TV application 90 to appropriate user-friendly sub-channel identifiers for display in the EPG

In a preferred embodiment of the invention, when tuned to a service on a multiplex, the TV application 90 will automatically identify all EPG services on the applicable multiplex and will download and decode them. EPG services are appropriately signaled to the TV application 90 by the DAB receiver module 60. Thus in one embodiment, the SCId of the packet service is signalled by FIG0/2 with TMId=11b (MSC packet data) and each EPG service is provided with a single primary service component. Data group DG=0, DSCTy=111100b (MOT), the sub-channel ID used to carry the data, and the DB packet address used within that sub-channel for the services are signaled by FIG0/3 and the corresponding SCId. In some embodiments, multiple data streams are carried within the same sub-channel. This requires each data stream to use different packet addresses, increases the receiver power consumption and can also decrease the Reed-Solomon forward-error correction.

### Provision of Header Files & Decryption Keys

As mentioned above, to decode sub-channels that have been encrypted prior to broadcast, the co-processor 54 requires access to an associated decryption key, unless the sub-channel is the EPG sub-channel or a free-to-air sub-channel. Furthermore, the decoders 95a,b,c, require access to a header file associated with the sub-channel, the header file comprising codec information defining how the video/audio is to be rendered. In the context of the Windows Media (WMV) codec, this header file is known as a NetShowContainer (NSC) file which contains, amongst other information, a format block defining the format of the data, the display resolution (in the case of video data) and the bit rates at which the video and/or audio data should be played by the media player. With conventional streaming, this header file is acquired when a user selects a WMV file to be played; the media playing software will request the header file over a one-to-one bidirectional link to a streaming server. Here, the streaming data is received over a unidirectional broadcast channel and so there is no bidirectional link. It is therefore necessary to provide the co-processor 54 with access to a batch of header files corresponding to respective channels in a provisioning step, to be described below. Received header files are stored in the SDRAM or Flash memory 55, 56 and are accessed by the video/audio decoder 33 when a particular channel is selected for output.

The licence data, which provides the DRM decryption keys, and the abovementioned NSC header files are acquired by the co-processor 54 via the host bus 70 by means of using the UMTS/GSM transceiver 42 of the handset 24, particularly the General Packet Radio Service (GPRS) function. Referring to FIG. 6, in a first step 6.1, the TV application sends a request message over the host bus 70 for a particular service. In response, in a second step 6.2, the transceiver 42 establishes a GPRS channel with a Service

Management System (SMS) 100 via an Internet Service Provider and sends a message specifying the selected service (which may be a single channel or batch of channels) and an identifier, which in this case is specific to the co-processor 54. The message is sent in response to confirmation from the user that the required payment is to be added to their next bill. In a third step 6.3, the SMS 100 identifies the user, selected channel(s) and payment amount to a transaction and billing server 101 which verifies the transaction (i.e. confirms that the identified user is not blocked from receiving the service and that the payment has been added to their account). In a fourth step 6.4, an authorisation message is sent back to the SMS 100. In response to verification, in a fifth step 6.5, the SMS 100 transmits updated NSC file(s) and decryption key(s) enabling decoding and decryption of the requested content to the transceiver 42 over the GPRS backchannel. In a sixth step 6.6, the NSC file(s) and key(s) are transferred over the host bus 70 to the co-processor 54 where they are stored securely either in the SDRAM or Flash memory 55, 56.

For added security, the NSC file(s) and/or key(s) can be themselves encrypted or locked by the SMS 100 in such a way that they are specific to the requesting co-processor 54. That is, the NSC file(s) and/or key(s) may include additional licensing information specifying an identifier unique to the co-processor 54 such that the keys can only be decrypted by an application running on that co-processor. The serial number of the co-processor 50 can be used as the unique identifier, for example. This prevents unauthorised use of the NSC file(s) and key(s) should they be intercepted in the GPRS backchannel and a decryption attempt made at any device other than the requesting handset.

As an alternative to sending the NSC file(s) and key(s) direct to the handset using GPRS, the SMS 100 can send a so-called fulfillment file to the handset via the WAP Push protocol. The fulfillment file will comprise MIME type hyperlinks which are automatically activated at the handset 39 to download the NSC file(s) and/or key(s) using GPRS. This may be appropriate where the file(s) and/or key(s) are held at a server which is different from the SMS 100.

The NSC file(s) and/or decryption key(s) will usually have a limited period of validity to prevent unauthorised users who have intercepted the file(s)/key(s) from accessing a channel for a long time period. In the TV application, the DRM decryption function 96 is arranged to compare validity period information associated with the particular NSC file or decryption key with the current date and time generated by the RTC 68. If this date and time is outside the validity period, the DRM decryption module 96 will not permit decryption nor pass the NSC file to the relevant decoder 95b,c. The validity period can be conveniently indicated in the actual file name of the NSC file or decryption key, for example using the format “ nsc_<Sld>_<StartTime>_<EndTime>.nsc” where Sld is the service ID of the DAB channel to which the NSC file applies; in the DAB standard, the service ID is a code unique to a given channel and so by placing this in the actual filename of its associated NSC file enables matching by the TV application when a particular channel is selected for output. For memory management purposes, the TV application is arranged automatically to purge or delete NSC files and/or keys once it is determined they are no longer valid. In this respect, the amount of memory present in the SDRAM or Flash memory 55, 56 will be limited and over time the memory may approach its maximum capacity unless some deletion strategy is employed. Furthermore, where two or more header files associated with a common service are identified, i.e. header files having a filename part identifying a common serviceID, a selection strategy is required to identify which one of the plurality of header files to use and which to ignore and/or delete.

The different states in which the TV application operates will now be described with reference to FIG. 7. In a first step 7.1, the application is launched. This may be in response to a number of user actions, including (a) selection from a menu on the handset operating system or (b) actuation of a dedicated element, e.g. key, switch or touchpad, provided on the casing of the handset. In step 7.2 the TV application's user interface presents a ‘splash screen’ which is a pre-stored image having a number of purposes. First, the splash screen acts as a holding screen which is displayed whilst any obsolete data is removed from memory. The time the image is displayed will depend on the amount of processing necessary to clear the obsolete data. Second, the splash screen provides brand, version and copyright information. Once connected, in step 7.3, it is determined whether the TV application is being run for the first time, in which case a scan of available services is performed in step 7.4. This involves requesting an up-to-date set of EPG information from the EPG database 97. Following this, or if it is not the first time of operation, EPG data is displayed in step 7.5. Thereafter, the user may select a channel by moving a cursor to the desired audio or video programme and pressing a select key (steps 7.6 and 7.7). If the selected channel is a free-to-air channel requiring no decryption, the application will decode and play the resulting data stream using the media playing application, i.e. Windows Media Player 9. If the selected channel is a channel requiring decryption, the TV application will check that valid licence information is stored in available before extracting the decryption key from the licence and decrypting the selected channel for output on the media playing software. If no such license information is stored, the application will output an error message prompting the user to acquire a license or licenses. This may involve the user making a one-off payment, e.g. for a pay-per-view event or a short term subscription, or a recurring payment for a longer-term subscription. Any number of business/payment models can be used by service providers. If the user proceeds with payment, the appropriate licenses and NSC files are received by the handset for secure storage in the SDRAM or Flash memory 55, 56. At any time during playback of a media stream, the user can obtain programme details (step 7.8) for example to get a summary of the programme name and the content, or interact (step 7.9) in which case a web page is launched enabling web-based information relevant to the current programme to be acquired.

### Software Updates

From time to time, it may be necessary to update or upgrade software used by the co-processor 54, for example its operating system and/or the TV application and its associated components.

It is preferred that the co-processor operating system be upgraded using the USB port 48 associated with the host processor 48. The upgrade will be made via the HPI 80. Where the co-processor 54 is supplied without an operating system, this ‘upgrade’ may be the first time installation and the following steps are intended to apply to this process in the same way as for a conventional upgrade:
1) Host processor recognises OS upgrade from USB port;
2) Host processor puts co-processor into boot mode by asserting co-processor reset line;
3) Co-processor starts in boot mode and sends status message to host processor;
4) Host processor requests free RAM memory location from co-processor;
5) Host processor transfers operating system to co-processor RAM 55 via host bus 70 and HPI 80;
6) Host processor informs co-processor boot loader via CCI 72 that new operating system is available;
7) Co-processor boot loader copies operating system from RAM to Flash 56;
8) Co-processor boot loader returns status message to host processor via CCI 72.

Installation or upgrading of the TV application will be performed using corresponding steps 1 to 8 above.

The TV application preferably includes an option whereby it checks for upgrades. When this option is enabled, a GPRS connection will be opened to a server which stores relevant patch programs for subsequent' downloading via GPRS to the co-processor's operating system file system whereafter it is stored in Flash memory 56.

### Software Security

In prior art devices, in order to enforce a software license associated with the TV application, the host processor can securely access the IMEI (International Mobile Equipment Identity) number of the handset. The IMEI is a number unique to the handset and can therefore be used to store a stolen device from accessing the network and also, as in this case, to enforce software licenses. This is performed by ensuring that the TV application can work only within a certain range of IMEI numbers. In the present modified system, however, the co-processor 54 running the TV application will not necessarily have independent and secure access to the handset's IMEI. Furthermore, the code used for enforcing the TV application license might be circumvented.

It is therefore required to identify an alternative unique handset identifier which can be compared with the license file to verify the TV application software. This might be achieved by listing the individual co-processor identifiers in the license file. Alternatively, the 64-bit unique identification number of the DAB baseband processor 58 can be employed to lock the software to a batch of DAB modules. The co-processor 54 obtains the unique identification number via the SPI interface. Whichever unique identifier is used, it is preferable that the licensing information for the TV application be encrypted to prevent, or at least deter, circumvention.

In summary, the embodiment described above provides an architecture and operating method for providing additional functionality to a wide range of portable telephones, PDAs and other similar devices, notwithstanding the fact that they employ different processors, architectures and operating systems which may on their own be unsuitable for providing the additional functionality in an efficient way. This is achieved by connecting a co-processor 54 to the host processor 40 and using the co-processor to provide the additional functionality independently of the host processor. This allows the host processor 40 to operate in largely the same way as before with reduced likelihood that the functions implemented thereon will be affected by the additional functionality, for example by slowing down the host processor. Software used to implement the additional functionality is largely portable in that it does not have to be specially coded to suit different processors and operating systems.

Although the preferred embodiment has been described with reference to a DAB receiving function, this is not intended to be limiting and other functions can be employed for running on the co-processor 54.

A second preferred embodiment will now be described with reference to FIG. 8 which shows a system similar to that of the FIG. 2 system but which differs in that the host processor 40 and co-processor 54 are provided in different respective devices 39, 104 interconnected by a non-fixed data channel 105. The respective devices 39, 104 may be separate self-contained devices in which, for example, the first device 39 is a wireless telephony device such as a UMTS mobile telephone and the second device 104 is an accessory providing an additional communications service, e.g. the DAB t.v./radio service described previously. The connection between the two devices may be wired or wireless. In the case of a wireless connection, a suitable wireless protocol such as Bluetooth can be employed. Although not shown in FIG. 8, each device 39, 40 will comprise interface software for handling the signals passing between the two processors 40, 54. The respective interface may set up a secure data channel on the channel 105, e.g. using the Secure Sockets Layer (SSL) transport layer protocol, to prevent unauthorised access to data as it passes over said channel.

In this embodiment, the display 52 is connected to the UMTS processor 40. However, as with the first embodiment, display data output by the co-processor 54 takes precedence over that output by the host processor 40 and is displayed in its place. Otherwise, the operation of the various components making up the two devices is as described above with respect to the first embodiment.

1.-22. (canceled)

23. A communications system comprising:
an existing mobile communications system (39) including:
a first processor (40); and
a display means (52); and
integrated additional hardware and software components providing a broadcast digital television and/or radio service comprising a second processor, wherein a connection between the first processor (40) and the display 52 is inhibited and is controlled by the additional hardware,
wherein in the communications system said first and second processors (40,54) are arranged to run respective first and second programs each associated with a different communications service; and
wherein the second processor (54) is electrically connected between the first processor (40) and the display means (52) and arranged such that:
in a first operating mode in which the second program is inactive, display data generated by the first program is transferred to the display means (52) via the second processor (54), and
in a second operating mode in which the second program is active, display data generated by the second program is output to the display means (52) in place of display data from the first processor (40).

24. A system according to claim 23, wherein, in the first operating mode, the second processor is arranged to provide a direct electrical link between the first processor and the display means.

25. A system according to claim 23, further comprising user control means connected to the first processor, and wherein, when run in the second operating mode, the first processor is arranged in use to transfer control data from the user control means to the second program.

26. A system according to claim 23, wherein the second processor is arranged, in the second operating mode, to receive notification data from the first processor and subsequently to cause the second program to indicate in its display data receipt of said notification data.

27. A system according to claim 26, wherein the notification data is indicative of an incoming communications request received by the communications service provided on the first processor, the second program being arranged to indicate in its display data the incoming communications request and to enable user acceptance of the incoming request.

28. A system according to claim 27, wherein, in response to user acceptance of the incoming request, the second program is arranged to transfer user control, at least temporarily, to the communications service on the first processor.

29. A system according to claim 23, wherein the first and second processors are powered by respective power supplies which are independent of one another, and wherein, when the communications service program is inactive, the second processor power supply is arranged automatically to enter a low power state relative to the first processor power supply.

30. A system according to claim 23, comprising a wireless communications system which comprises a mobile telephone or PDA in which the first processor is connected to a UMTS/GSM transceiver and provides one or more voice communications services.

31. A system according to claim 23, wherein the first processor is connectable to an internet protocol (IP) node and in which the second processor is operable, in the second operating mode, to initiate connection to an available IP node via the first processor.

32. A system according to claim 23, wherein the first processor is connectable to the IP node via an associated GPRS transceiver for detecting and establishing a connection with an available IP node.

33. A system according to claim 23, wherein the second processor is connected to a digital broadcast receiver and the second program is arranged to decode content received therefrom for output to the display means.

34. A system according to claim 33, wherein the digital broadcast receiver is arranged to receive video and/or audio content conforming to a digital audio broadcast (DAB) standard protocol and the second program is arranged to decode the received content for output to the display means.

35. A system according to claim 33, wherein the second program is arranged to decode content from a selected one of a plurality of channels received at the digital broadcast receiver.

36. A system according to claim 23, wherein the first and second processors are physically separate and interconnected by one or more data buses.

37. A method of modifying an existing mobile communications system including a first processor (40) and a connected display means (52) to enable the existing mobile communications system to provide a broadcast digital television and/or radio service, the method comprising:
integrating additional hardware and software components providing said broadcast digital television and/or radio service, the additional hardware including a second processor, wherein the connection between the first processor and the display 52 is inhibited and is controlled by the additional hardware,
operating a communications system comprising said first and second processors (40, 54) arranged to run respective first and second programs each associated with a different communications service, the second processor being electrically connected between the first processor and a display means;:
in a first operating mode in which the second program is inactive, transferring display data generated by the first program to the display means via the second processor; and
in a second operating mode in which the second program is active, outputting display data generated by the second program to the display means in place of any display data from the first processor.
